(19) United States
(12) Patent Application Publication
(10) Pub. No.: US 2020/0300091 A1
(43) Pub. Date: Sep. 24, 2020

(54) SURFACE TEXTURE AND GROOVE DESIGNS FOR SLIDING CONTACTS

(71) Applicant: Northwestern University, Evanston, IL (US)

(72) Inventors: Qian Wang, Mt. Prospect, IL (US); Zhong Liu, Evanston, IL (US)

(21) Appl. No.: 16/613,484

(22) PCT Filed: May 14, 2018
(86) PCT No.: PCT/US2018/032562

§ 371 Date: Nov. 14, 2019

Related U.S. Application Data
(60) Provisional application No. 62/507,338, filed on May 17, 2017.

(51) Int. Cl. F01C 1/10; F01C 1/22; F01C 19/02; F16J 1/02; F16J 10/04; F01C 21/08

(52) U.S. Cl. CPC F01C 1/10; F01C 1/22; F01C 19/02; F04C 2230/92; F16J 10/04; F01C 21/08; F16J 1/02

(57) ABSTRACT

A sliding contact assembly includes a first surface and a second surface. The second surface of the sliding contact assembly is configured to slide over the first surface, and at least a portion of the second surface contacts the first surface to form at an interface between the first surface and the second surface. The sliding contact assembly also includes a plurality of textures on the portion of the second surface that contacts the first surface. A density of the plurality of textures is not uniform over the portion of the second surface that contacts the first surface. The sliding contact assembly can include apex seal to housing interfaces in rotary engines, roller to roller interfaces, roller to housing interfaces, bearing to surface interfaces, etc.

### CROSS-REFERENCE TO RELATED APPLICATIONS

The present application is a National Stage entry of PCT App. No. PCT/US2018/032562 filed on May 14, 2018, which claims the priority benefit of U.S. Provisional Patent App. No. 62/507,338 filed on May 17, 2017, the entire disclosures of which are incorporated herein by reference.

### BACKGROUND

Finite length rollers in sliding contacts can be found in many mechanical systems, including apex seal-housing interfaces in rotary engines. For the rotary engine, the seal-housing interface is an important component that can be a point of engine failure. Additionally, the tribological performance of the apex seal-housing interface is directly related to the working life of the rotary engine system. In rotary engine and other sliding contact systems, rollers/rotors are often designed to have crowns to cancel possible misalignment at the interface, thermal deformation, and non-uniform load distribution.

### SUMMARY

A sliding contact assembly includes a first surface and a second surface. The second surface of the sliding contact assembly is configured to slide over the first surface, and at least a portion of the second surface contacts the first surface to form at an interface between the first surface and the second surface. The sliding contact assembly also includes a plurality of textures on the portion of the second surface that contacts the first surface. A density of the plurality of textures is not uniform over the portion of the second surface that contacts the first surface. The sliding contact assembly can include apex seal to housing interfaces in rotary engines, roller to roller interfaces, roller to housing interfaces, bearing to surface interfaces, etc.

An illustrative rotor assembly includes a rotor having at least one apex and an apex seal at the at least one apex of the rotor. The apex seal forms an interface between the rotor and a housing. A sealing surface of the apex seal includes a plurality of textures, where a density of the plurality of textures is not uniform over the sealing surface of the apex seal. Also, a surface of the housing includes a pair of parallel grooves that are configured to prevent leakage at the interface between the apex seal and the housing.

An illustrative rotary engine includes a housing having an interior surface that defines a rotor cavity and a rotor mounted in the rotor cavity, where the rotor has at least one apex. An apex seal is located at the at least one apex of the rotor, where the apex seal includes a sealing surface that forms an interface between the rotor and a housing. The rotor is configured such that the sealing surface of the apex seal is in sealing contact with at least one area of the interior surface of the housing as the rotor rotates in the rotor cavity. The interior surface of the housing defines a pair of parallel grooves formed within the at least one area of the interior surface of the housing such that the parallel grooves run in a rotational direction of the rotor.

### BRIEF DESCRIPTION OF THE DRAWINGS

Illustrative embodiments of the invention will hereafter be described with reference to the accompanying drawings, wherein like numerals denote like elements.

FIG. 1A depicts a rotary assembly of a rotary engine in accordance with an illustrative embodiment.

FIG. 1B depicts a rotor assembly of a four-stroke rotary engine in accordance with an illustrative embodiment.

FIG. 2A depicts an apex seal for a rotor assembly in accordance with an illustrative embodiment.

FIG. 2B depicts apex seal sections cut from an apex seal and used to perform experiments and simulations in accordance with an illustrative embodiment.

FIG. 3 depicts a texturing in a middle area of an apex seal in accordance with an illustrative embodiment.

FIG. 4 depicts a texturing along a trailing edge of an apex seal in accordance with an illustrative embodiment.

FIG. 5 depicts a texturing along a leading edge of an apex seal in accordance with an illustrative embodiment.

FIG. 6 depicts a comparison of simulation textures to real word textures in accordance with an illustrative embodiment.

FIG. 7 depicts example depth profiles of textures in accordance with an illustrative embodiment.

FIG. 8A depicts the minimum film thickness (hₘᵢₙ) for R, T2, and T3 type depth profiles at the depth of 1 micron in accordance with an illustrative embodiment.

FIG. 8B depicts coefficient of friction (CoF) for R, T2, and T3 type depth profiles at the depth of 1 micron in accordance with an illustrative embodiment.

FIG. 9A depicts center line pressure distributions for R, T2, and T3 type depth profiles in accordance with an illustrative embodiment.

FIG. 9B depicts film thickness distributions for R, T2, and T3 type depth profiles in accordance with an illustrative embodiment.

FIG. 10 depicts the central film thickness, minimum film thickness, and coefficient of friction under different depths for an R type depth profile in accordance with an illustrative embodiment.

FIG. 11A depicts an apex seal surface with full texturing in accordance with an illustrative embodiment.

FIG. 11B depicts dimensions of an oval (or dimple) texture used in the simulations in accordance with an illustrative embodiment.

FIG. 11C depicts dimensions of a rectangular (or groove) texture used in the simulations in accordance with an illustrative embodiment.

FIG. 12A depicts a parallel groove housing design in accordance with an illustrative embodiment.

FIG. 12B depicts cross-sectional views of parallel grooves having different depth profiles along the line A-A in FIG. 12A in accordance with an illustrative embodiment.

FIG. 13A is a table showing working condition parameters for parallel groove analysis in accordance with an illustrative embodiment.

FIG. 13B is a table showing texture parameters for the parallel groove analysis in accordance with an illustrative embodiment.

FIG. 14 depicts the relative side leakage under different depth profiles for the parallel groove designs in accordance with an illustrative embodiment.

FIG. 15 shows the relative side leakage under different groove depths in accordance with an illustrative embodiment.

FIG. 16A depicts a crowned roller contacting a surface in accordance with an illustrative embodiment.

FIG. 16B is a bottom view of the crowned roller in accordance with an illustrative embodiment.

FIG. 17A is a table that includes test parameters for a crowned roller interface in accordance with an illustrative embodiment.

FIG. 17B is a graph depicting film thickness increase and CoF decrease for various test scenarios in accordance with an illustrative embodiment.

FIG. 18A depicts a pressure distribution for a smooth crowned roller interface in accordance with an illustrative embodiment.

FIG. 18B depicts a pressure distribution for a crowned roller interface having optimal partial texturing in accordance with an illustrative embodiment.

FIG. 18C depicts a film thickness distribution for a smooth crowned roller interface in accordance with an illustrative embodiment.

FIG. 18D depicts a film thickness distribution for a crowned roller interface having optimal partial texturing in accordance with an illustrative embodiment.

FIG. 19A depicts a centerline pressure comparison (bottom) and a film comparison (top) in a width direction for a crowned roller interface in accordance with an illustrative embodiment.

FIG. 19B depicts a centerline pressure comparison (bottom) and a film comparison (top) in a length direction for a crowned roller interface in accordance with an illustrative embodiment.

### DETAILED DESCRIPTION

As discussed above, traditional sliding contact systems (or assemblies) often include rollers (or sliders or rotors) that are designed with crowns in an effort to avoid interface misalignment, thermal deformation, and non-uniform load distribution. Most of the research performed on sliding contact systems focuses on point contacts and line contacts. However, in traditional systems, no systematic work has been performed to improve the tribological performance of components in roller sliding contacts. Described herein are sliding contact systems that improve tribological performance as compared to traditional systems by the incorporation of surface texture designs to interface components.

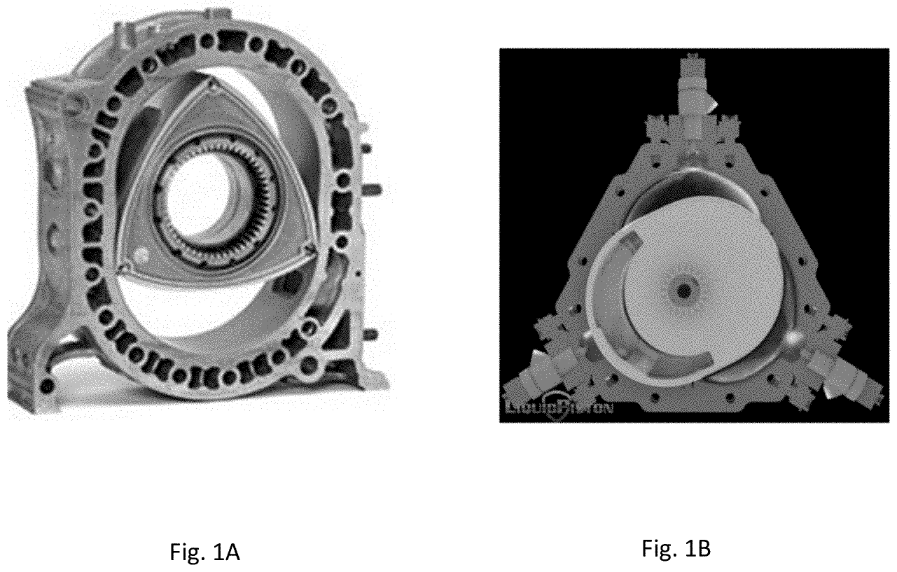

Also described herein are rotor assemblies and rotary engines and other systems that incorporate the rotor assemblies. The rotor assemblies can be used as roller sliding contacts in a variety of applications where the rotors (also referred to as rollers) are configured to slide across and seal against a mating surface. Some embodiments of the rotor assemblies include a rotor with an apex seal that provides a sealing surface. For example, the rotor assemblies can be part of a rotary engine in which the apex seal (or apex seals) of the rotor rotates against the interior surface of a rotor housing. FIG. 1A depicts a rotary assembly of a rotary engine in accordance with an illustrative embodiment. FIG. 1B depicts a rotor assembly of a four-stroke rotary engine in accordance with an illustrative embodiment. In FIGS. 1A and 1B, each of the rotor assemblies includes a rotor that is configured to slide along a surface of a housing to enable operation of the engine. The rotor assemblies can also provide roller sliding contacts in other machine components, including reciprocating mechanical seals for pumps, blades of cleaning equipment, roller bearings, etc.

In one embodiment, the sealing surface of an apex seal (or housing) of the rotor assembly can be partially textured with one or more indentations to reduce resistance and improve efficiency of the system. In other embodiments, a pair of parallel grooves can be defined in the mating surface, along the direction of movement of the rotor, to prevent leakage in the system. In an illustrative embodiment, the textured sealing surfaces, grooves, etc. described herein can be applied to apex seals having a variety of sizes and curvature shapes.

The partially textured surfaces of the apex seals and the grooves in the mating surfaces are designed to reduce side leakage, enhance lubrication, and/or extend the working life of components in the roller sliding contacts. For example, herringbone grooves may be defined in the mating surface for a roller to reduce the volume of a lubricant at the edges of the contact area between the mating surface and the roller and to increase lubricant flow to the middle contact area. The textured roller profiles are designed to reduce the pressure concentration, to get more uniformly distributed pressures and films, and to increase minimum film thicknesses. As used herein, film thickness can refer to the thickness of an elastohydrodynamic lubrication film at a contact interface. Combinations of the herringbone grooves and the textured roller profile designs can achieve a combination of the benefits offered by each.

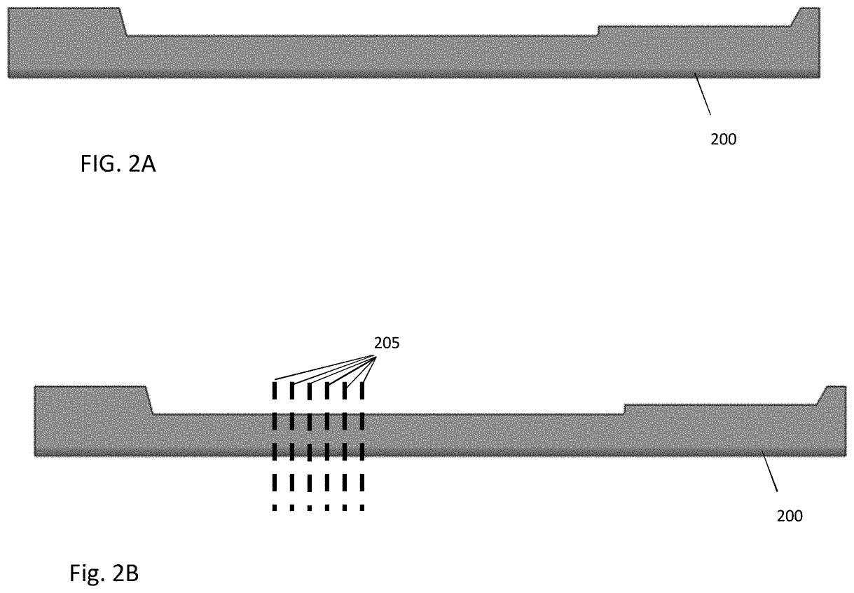

FIG. 2A depicts an apex seal 200 for a rotor assembly in accordance with an illustrative embodiment. As depicted in FIG. 2A, the apex seal 200 has an even bottom surface and an uneven top surface such that the apex seal 200 is able to conform to a housing. In alternative embodiments, the apex seal can have a different shape depending on the application. FIG. 2B depicts apex seal sections cut from the apex seal 200 and used to perform experiments and simulations in accordance with an illustrative embodiment. In FIG. 2B, the apex seal sections are delineated by dashed lines 205.

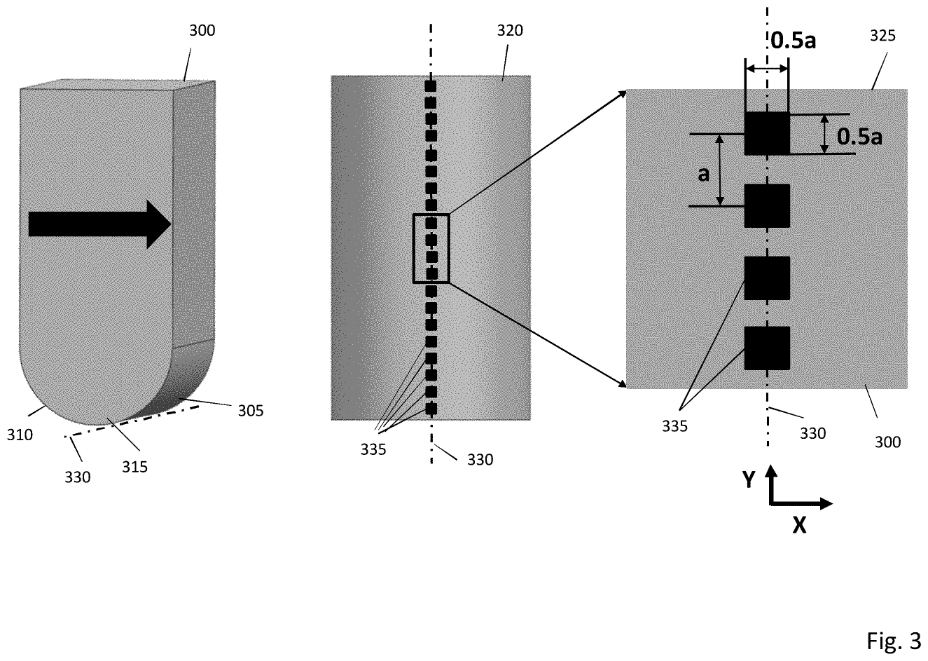

As discussed above, including one or more textures on a contact surface of the apex seal can be used to improve the overall functionality of the rotor assembly. FIGS. 3-5 depict various texture embodiments in which partial texturing is included on the sealing surface of the apex seal. In alternative embodiments, the partial texturing may be included on the housing along which the apex seal slides.

FIG. 3 depicts a texturing in a middle area of an apex seal 300 in accordance with an illustrative embodiment. At left, FIG. 3 includes a perspective view of the apex seal 300, along with an arrow to indicate the direction of sliding movement of the apex seal 300. The apex seal 300 includes a leading edge 305 and a trailing edge 310. A bottom portion 315 of the apex seal contacts a surface as the apex seal 300 moves. The apex seal sample is sliding from left to right so that the front side of the blade of the apex seal 300 is the leading edge 305 and the back side of the blade of the apex seal 300 is the trailing edge 310.

FIG. 3 also depicts a bottom view 320 and an enlarged bottom view 325 of the apex seal 300. The vertical dashed line in the bottom view 320 and the enlarged bottom view 325 is a contact centerline 330 along the length direction (Y direction) of the apex seal 300. The contact centerline 330 is tangential and coincident to a bottom edge of the apex seal 300. As depicted, textures 335 are positioned in the middle area of the apex seal 300 such that the location of textures in the X direction is [−0.25a, 0.25a], where a is the Hertz contact radius (approximate contact radius) of the apex seal 300. As depicted in FIG. 3, the textures 335 are square, with each side having a length of 0.5a. As also depicted, the distance between the centers of adjacent textures along the Y direction is a. In alternative embodiments, different shapes and/or spacing between textures may be used.

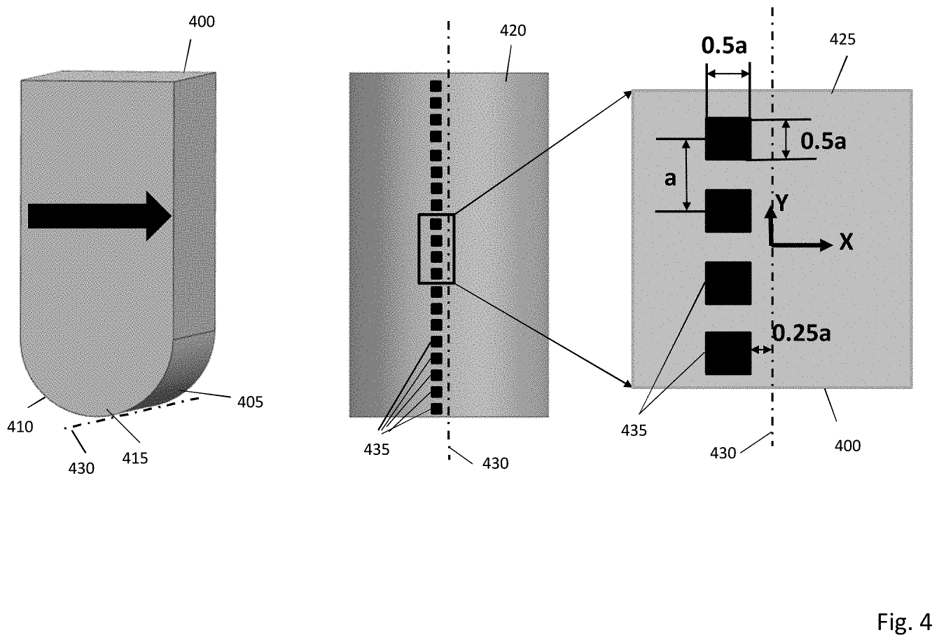

FIG. 4 depicts a texturing along a trailing edge 410 of an apex seal 400 in accordance with an illustrative embodiment. At left, FIG. 4 includes a perspective view of the apex seal 400, along with an arrow to indicate the direction of sliding movement of the apex seal 400. The apex seal 400 includes a leading edge 405 and the trailing edge 410. A bottom portion 415 of the apex seal contacts a surface as the apex seal 400 moves. The apex seal is sliding from left to right so that the front side of the blade of the apex seal 300 is the leading edge 305 and the back side of the blade of the apex seal 300 is the trailing edge 310.

FIG. 4 also depicts a bottom view 420 and an enlarged bottom view 425 of the apex seal 400. The vertical dashed line in the bottom view 420 and the enlarged bottom view 425 is a contact centerline 430 along the length direction (Y direction) of the apex seal 400. The contact centerline 430 is tangential and coincident to a bottom edge of the apex seal 400. As depicted, textures 435 are positioned along the trailing edge 410 of the apex seal 400 such that the location of textures in the X direction is [−0.75a, 0.25a], where a is the Hertz contact radius (approximate contact radius) of the apex seal 400. As depicted in FIG. 4, the textures 435 are square, with each side having a length of 0.5a. As also depicted, the distance between the centers of adjacent textures along the Y direction is a.

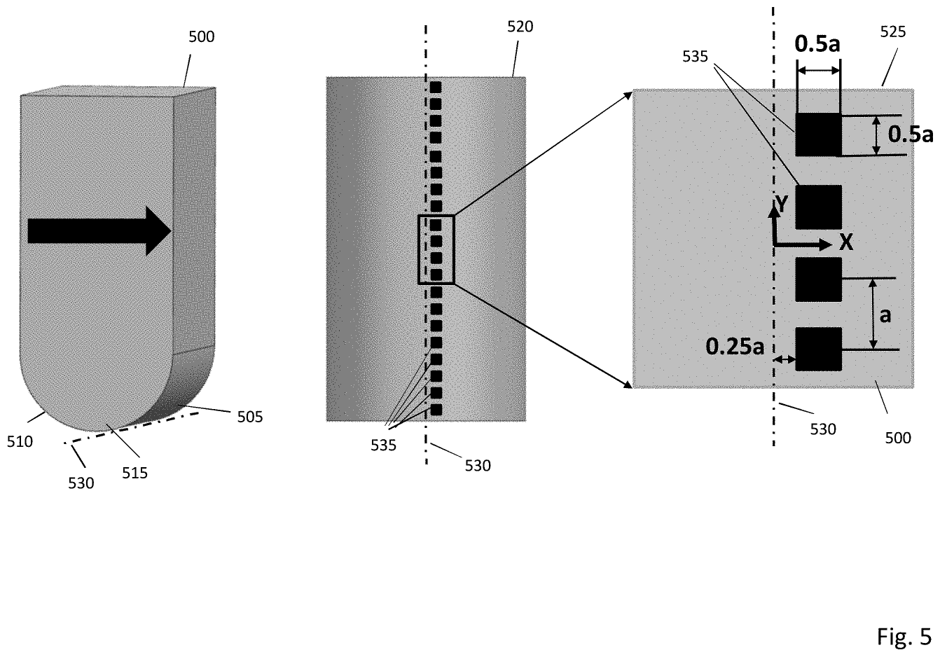

FIG. 5 depicts a texturing along a leading edge 505 of an apex seal 500 in accordance with an illustrative embodiment. At left, FIG. 5 includes a perspective view of the apex seal 500, along with an arrow to indicate the direction of sliding movement of the apex seal 500. The apex seal 500 includes the leading edge 505 and a trailing edge 510. A bottom portion 515 of the apex seal contacts a surface as the apex seal 500 moves. As depicted, the apex seal 500 is sliding from left to right so that the front side of the blade of the apex seal 500 is the leading edge 505 and the back side of the blade of the apex seal 500 is the trailing edge 510.

FIG. 5 also depicts a bottom view 520 and an enlarged bottom view 525 of the apex seal 500. The vertical dashed line in the bottom view 520 and the enlarged bottom view 525 is a contact centerline 530 along the length direction (Y direction) of the apex seal 500. The contact centerline 530 is tangential and coincident to a bottom edge of the apex seal 500. As depicted, textures 535 are positioned along the leading edge 505 of the apex seal 500 such that the location of textures in the X direction is [0.25a, 0.75a], where a is the Hertz contact radius of the apex seal 500. As depicted in FIG. 5, the textures 535 are square, with each side having a length of 0.5a. As also depicted, the distance between the centers of adjacent textures along the Y direction is a.

In FIGS. 3-5, the textures were depicted as square in shape. In alternative embodiments, the textures can have a different shape such as oval, circle, triangle, rectangle, etc. In one embodiment, a depth of the textures can be between 0.1-7 microns. Alternatively, different depths may be used. The textures can also have different lengths/widths depending on the implementation. As also depicted in FIGS. 3-5, a single row of textures was used such that a density of the textures is not uniform over the sealing surface of the apex seal. In alternative embodiments, different patterns may be used for placement of the textures on the seal.

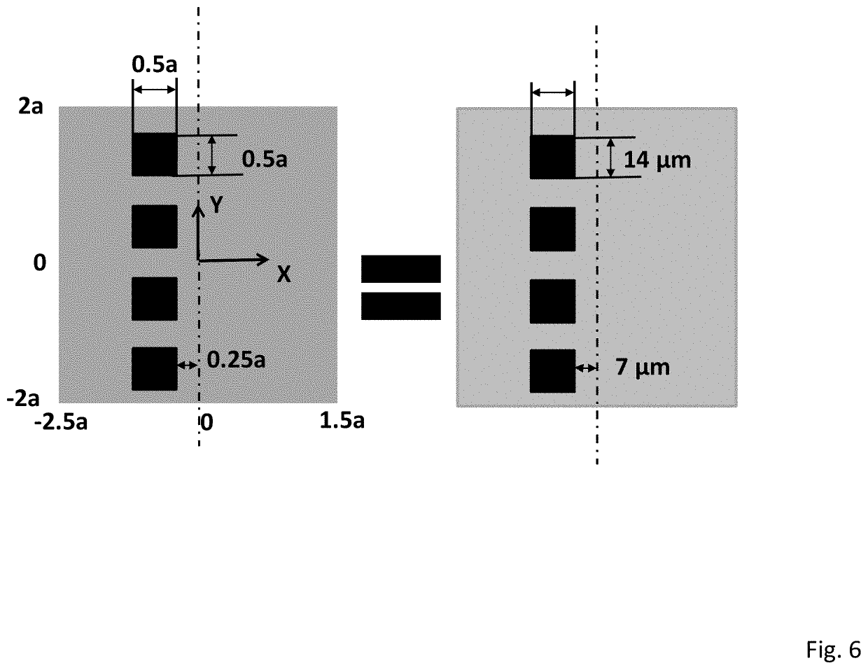

FIG. 6 depicts a comparison of simulation textures to real word textures in accordance with an illustrative embodiment. In the view of FIG. 6, the textures are depicted in the trailing edge of the apex seal. As shown in FIG. 6, 0.5a corresponds to 14 microns and 0.25a corresponds to 7 microns. A depth of the textures depicted in FIG. 6 is 3 microns. In alternative embodiment, different values may be used for the texture size, texture position, and/or texture depth.

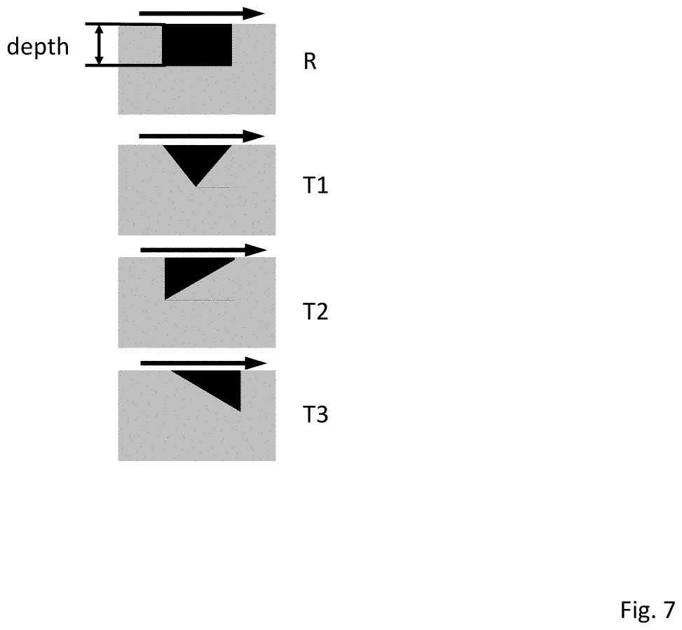

In addition to texturing on the apex seal, a surface upon which the apex seal slides can also include texturing/shapes incorporated therein. FIG. 7 depicts example depth profiles (or surface shapes) in accordance with an illustrative embodiment. The depicted depth profiles include an R surface shape, a T1 surface shape, a T2 surface shape, and a T3 surface shape. The depth profiles can be formed into a stationary housing substrate and/or used for the surface texturing on the apex seal. The arrows in FIG. 7 represent a flow direction of fluid in the system. Goals of the surface shapes formed in the housing are to reduce the coefficient of friction (CoF) and to increase the minimum thickness (hₘᵢₙ) of the apex seal.

A 3D line contact EHL model was used to study the influence of partial textures on tribological performance of a sliding contact system. When textures were on the upper sliding cylinder and the lower surface was stationary, textures were relatively stationary compared to the lower surface. Therefore, a steady-state model could be used to study partial textures on the upper sliding surface (apex seal). In the analysis, the domain was X: [−2.5a, 1.5a], Y: [−2a, 2a], where a is the maximum Hertz contact radius (e.g., 28.2 microns). The Erying model is used to represent the rheological properties of lubricant, with the Erying limiting shear stress set to 1.5 mega-Pascals (MPa). In alternative embodiments, a different limiting shear stress value may be used.

Four sets of simulations for partial texture designs based on line contact model were performed. All simulations involved square textures on the apex seal. The first set of simulation is the study of influence different depth profiles and locations when the depth is fixed at 1 micron. The results show that R and T3 depth profiles are good for lubrication enhancement. In the second set of the simulation, an R type bottom shape (depth profile) was used and depth/location were varied. This resulted in an increase of minimum seal thickness (hₘᵢₙ) and a decrease in CoF when depth is larger than 1 micron. In a third set of the simulation, a T2 type bottom shape was used and depth/location were varied. This resulted in a scenario where it was difficult to increase hₘᵢₙ. In the fourth set of the simulation, a T3 type bottom shape was used and depth/location were varied. This resulted in an increase in hₘᵢₙ and a decrease for CoF for depths larger than 1 micron.

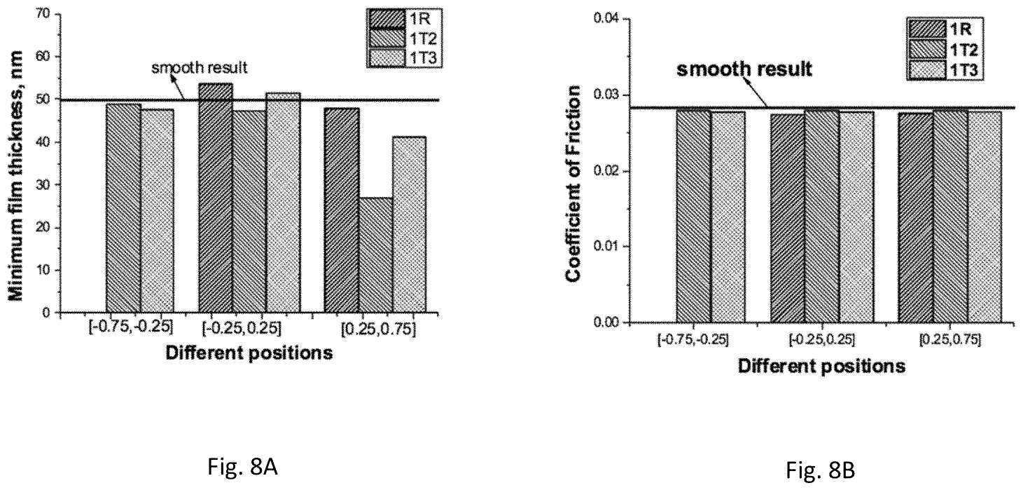

FIG. 8A shows results of the first set of simulations discussed above. Specifically, FIG. 8A depicts the minimum film thickness (hₘᵢₙ) for R, T2, and T3 type depth profiles at the depth of 1 micron in accordance with an illustrative embodiment. As shown, the minimum film thicknesses for R and T3 type depth profiles are thicker than the smooth result when the seal texture is in the position of [−0.25a, 0.25a]. FIG. 8B depicts coefficient of friction (CoF) for R, T2, and T3 type depth profiles at the depth of 1 micron in accordance with an illustrative embodiment. As shown, the CoF is reduced for R and T3 type bottom shapes when the seal texture is in the position of [−0.25a, 0.25a].

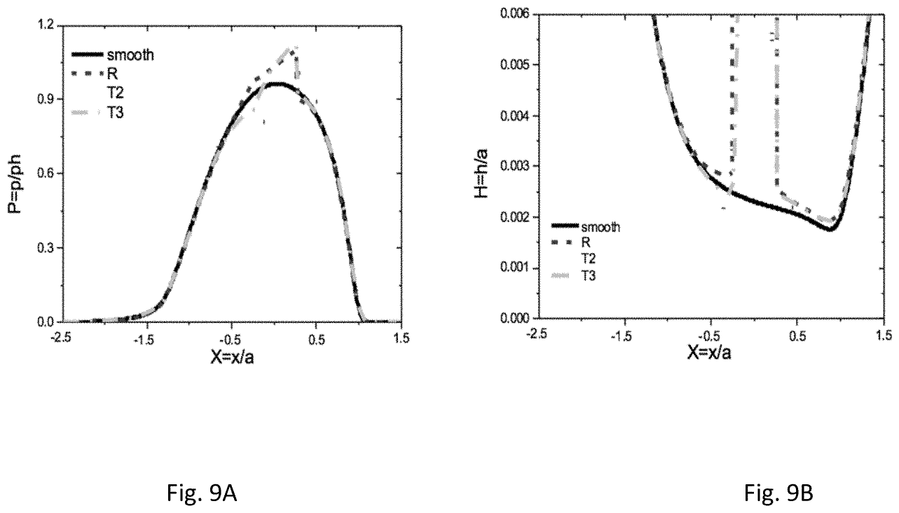

Pressure distributions and film thickness distributions were also plotted for the first set of simulations. FIG. 9A depicts center line pressure distributions for R, T2, and T3 type depth profiles in accordance with an illustrative embodiment. FIG. 9B depicts film thickness distributions for R, T2, and T3 type depth profiles in accordance with an illustrative embodiment. The plots of FIGS. 9A and 9B are for a fixed depth of 1 micron and a surface texture shape positioned at x—[−0.25, 0.25]. As shown, R and T3 type bottom shapes (or depth profiles) can help to build up the pressure at the textured area such that the pressure in the outlet area decreases as the total load is constant. As also shown, the film thickness for R and T3 type bottom shapes increases in the outlet area.

Referring to FIGS. 9A and 9B, it can be seen that for the T2 type bottom shape, the pressure dropped substantially at the left edge of textures, but for the T3 type bottom shape it dropped only a little, and for the R type bottom shape the pressure it increased a little. As the total load was constant, the drop/increase of pressure in this area may have caused the increase/drop of pressure in other areas. That is why the pressure in the original necking area from highest to lowest is: T2, smooth, T3 and R, which further results in a reasonable rank of minimum film thickness from thickest to thinnest: R, T3, smooth and T2 (i.e., minimum film thickness at the location [−0.25, 0.25] from FIG. 8A).

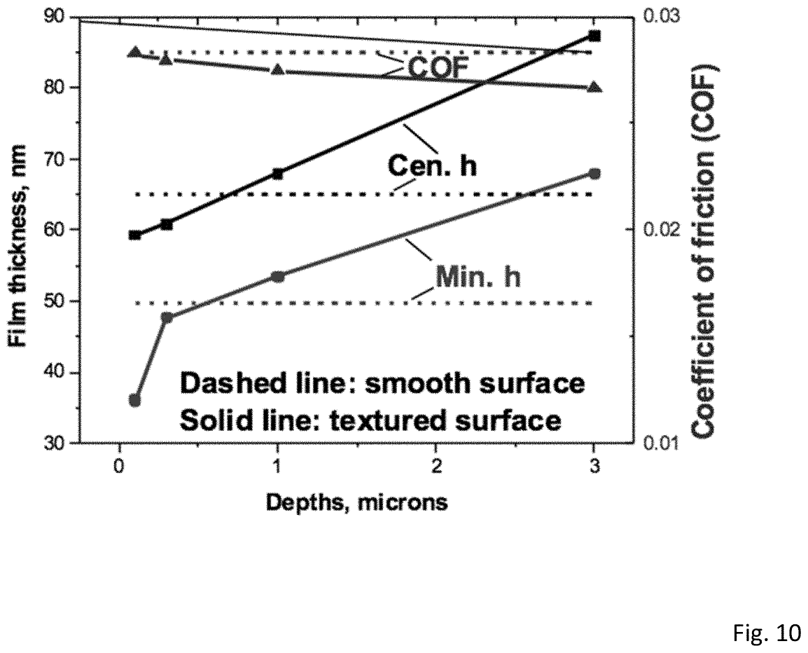

FIG. 10 depicts the central film thickness, minimum film thickness, and coefficient of friction under different depths for an R type depth profile in accordance with an illustrative embodiment. As shown, the deeper the depth of textures, the thicker the central film thickness and minimum film thickness, and the smaller the friction coefficient. When the depth of texture is greater than 0.5 micron, lubrication can be enhanced and meanwhile the coefficient of friction is reduced. For this particular simulation under the line contact model, the optimal partial texture case is an R type bottom shape with a depth of 3 microns and located at the middle contact area [−0.25, 0.25]. This partial texture can help for lubrication enhancement because the textures store more lubricant, and textures in the middle contact area under this working condition can help to build up pressure in the contact area. In an illustrative embodiment, a deeper depth with R type bottom shape of partial texture is beneficial because this kind of partial texture can store more lubricant.

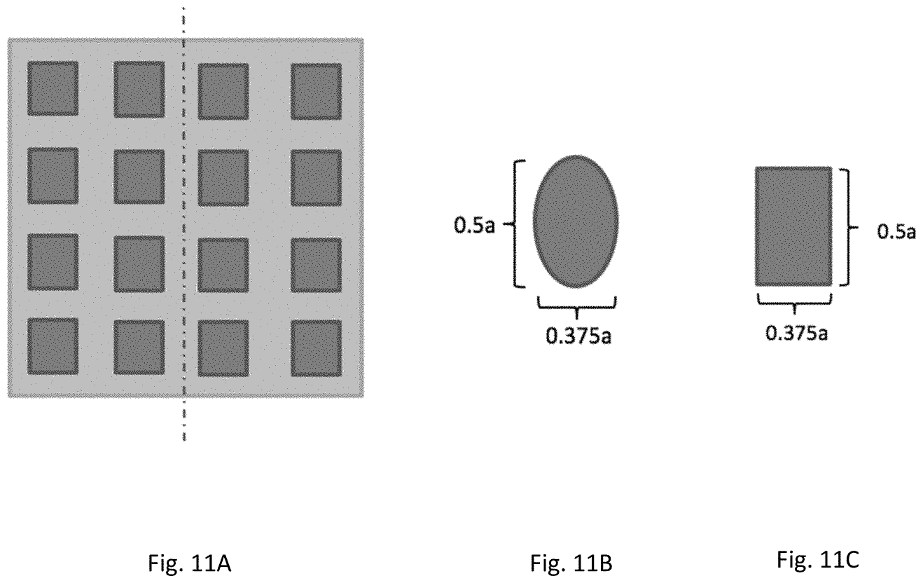

Additional simulations were also run for full textures on the apex seal surface (as opposed to a single row of textures as shown in FIGS. 3-5) such that the entire contact area is covered with partial textures. FIG. 11A depicts an apex seal surface 1100 with full texturing in accordance with an illustrative embodiment. FIG. 11B depicts dimensions of an oval (or dimple) texture used in the simulations in accordance with an illustrative embodiment. FIG. 11C depicts dimensions of a rectangular (or groove) texture used in the simulations in accordance with an illustrative embodiment. The full texture simulations were conducted using R, T1, and T3 type depth profiles at a 3 micron depth on the housing. Based on the simulations, it was determined that the minimum film thickness for the smooth case is about 247 nm, which is larger than all of the test cases with full textures. Therefore, it was determined that full texturing does not provide for lubrication enhancement.

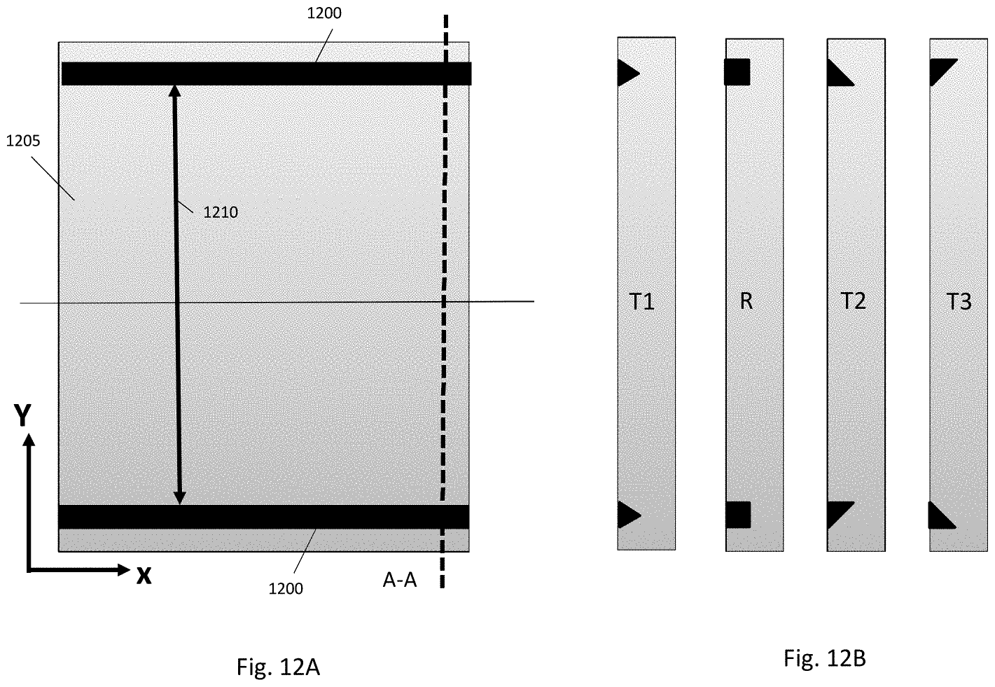

FIG. 12A depicts a parallel groove housing design in accordance with an illustrative embodiment. The parallel grooves 1200 are located on a housing surface 1205 and are designed to be as long as the housing surface in an effort to reduce side leakage. Alternatively, the grooves may have a different length, but should not be shorter than the contact length of the surface. There is a gap 1210 between the two parallel grooves 1200, which is one of the analyzed parameters along with the groove depth and the bottom shapes (i.e., depth profiles) along the Y direction. FIG. 12B depicts cross-sectional views of parallel grooves having different depth profiles along the line A-A in FIG. 12A in accordance with an illustrative embodiment.

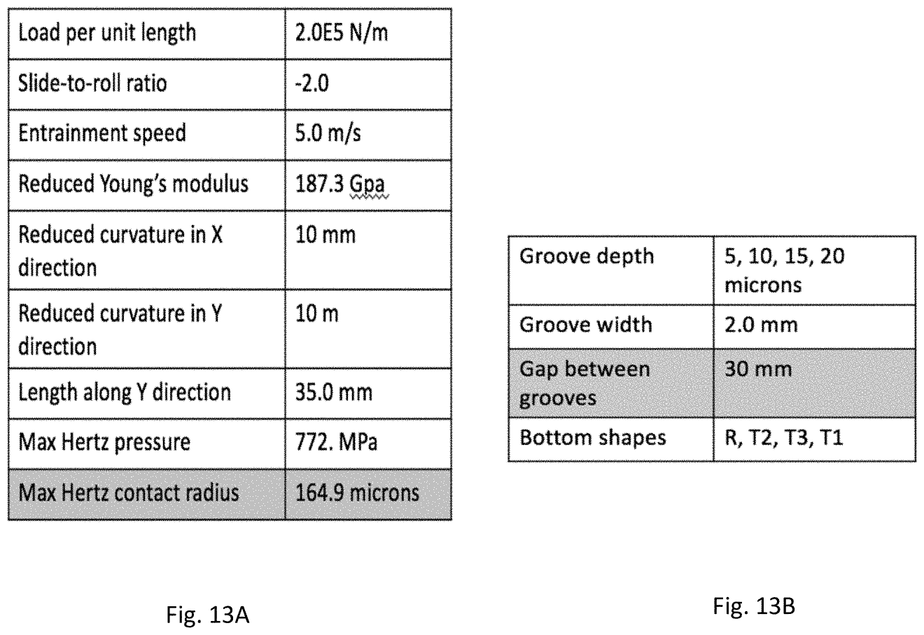

FIG. 13A is a table showing working condition parameters for parallel groove analysis in accordance with an illustrative embodiment. FIG. 13B is a table showing texture parameters for the parallel groove analysis in accordance with an illustrative embodiment. It was determined that a gap groove of 30 mm is enough to ensure that the minimum film thickness is not influenced by the parallel grooves.

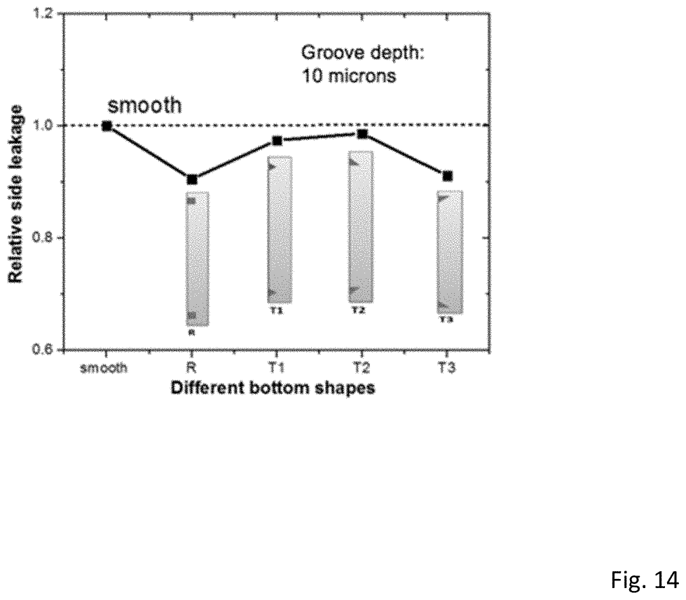

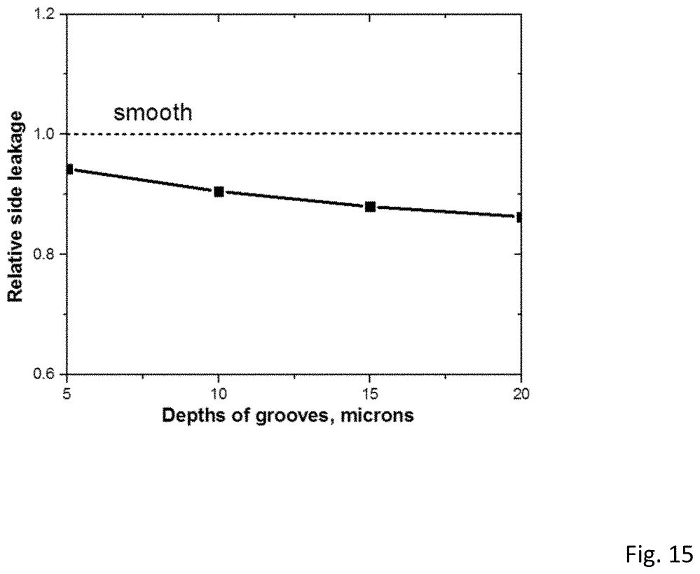

FIG. 14 depicts the relative side leakage under different bottom shapes for the parallel groove designs in accordance with an illustrative embodiment. The groove depth is fixed at 10 microns for the analysis depicted in FIG. 14. It can be seen that the relative side leakage for the cases with parallel grooves is smaller than that for cases with a smooth surface. It can also be seen that relative side leakage can be reduced the most through the use of grooves with R and T3 bottom shapes. FIG. 15 shows the relative side leakage under different groove depths in accordance with an illustrative embodiment. It can be seen from FIG. 15 that the deeper the parallel grooves, the smaller the relative side leakage, which means the side leakage can be reduced more. In an illustrative embodiment, there is no limit on how deep the grooves can be, as long they do not impact the structural integrity of the surface.

In an illustrative embodiment, it is possible to combine the partial texture design on the apex seal (or roller, rotor, other seal, etc.) described above and parallel groove design on the housing surface in the same model in order to enhance lubrication and reduce friction, as well as control side leakage. As discussed herein, R-type and T3-type bottom shapes with a proper depth and located at the middle contact area have been determined to increase both central film thickness and minimum film thickness, and to decrease friction coefficient. Additionally, side leakage can be controlled through parallel grooves with R and T3 type bottom shapes along Y direction, and the side leakage can be reduced more with deeper parallel grooves.

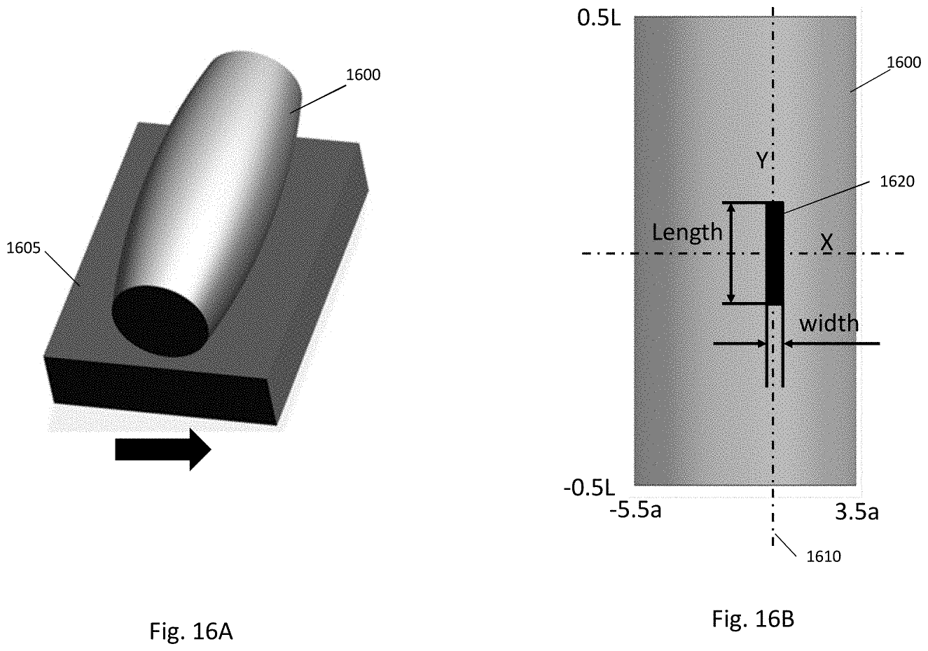

In another embodiment, partial texturing can be placed at a crowned roller interface to increase lubrication. FIG. 16A depicts a crowned roller 1600 contacting a surface 1605 in accordance with an illustrative embodiment. The crowned roller 1600 can be configured to slide along the surface 1605 in the direction shown by the arrow. In alternative embodiments, a different type of roller/rotor may be used. FIG. 16B is a bottom view of the crowned roller 1600 in accordance with an illustrative embodiment. In FIG. 16B, a is the Hertz contact radius and L is the length of the crowned roller 1600. A vertical dashed line 1610 represents a centerline of contact of the crowned roller 1600. As shown in FIG. 16B, a bottom surface of the crowned roller 1600 includes a groove 1620 that is vertically positioned at a center of the crowned roller 1600 and horizontally positioned along a leading edge of the crowned roller 1600. The groove 1620 can have any of the depth profiles described herein. In alternative embodiments, the groove 1620 can be a different type of texture and/or can have different dimensions and/or position on the crowned roller 1600. In another alternative embodiment, one or more grooves can be placed on the housing along with a depth profile (e.g., R, T1, T2, T3).

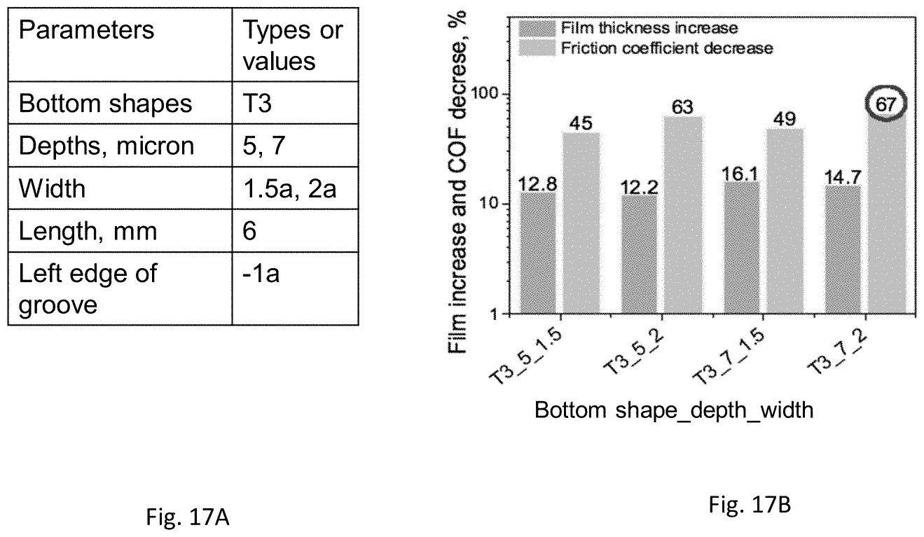

FIG. 17A is a table that includes test parameters for a crowned roller interface in accordance with an illustrative embodiment. Based on analysis, an optimal embodiment to reduce the CoF most significantly included a T3 type bottom shape with a depth of 7 microns, a groove length (on the roller) of 6 mm, a groove width of 2.0a, and a left edge of the groove (in the orientation of FIG. 16B) positioned at −1.0a. In alternative embodiments, other values may be used. FIG. 17B is a graph depicting film thickness increase and CoF decrease for various test scenarios in accordance with an illustrative embodiment. As shown, an optimal case for CoF decrease (circled) was the T3 bottom shape at a 7 micron depth and a 2a texture width.

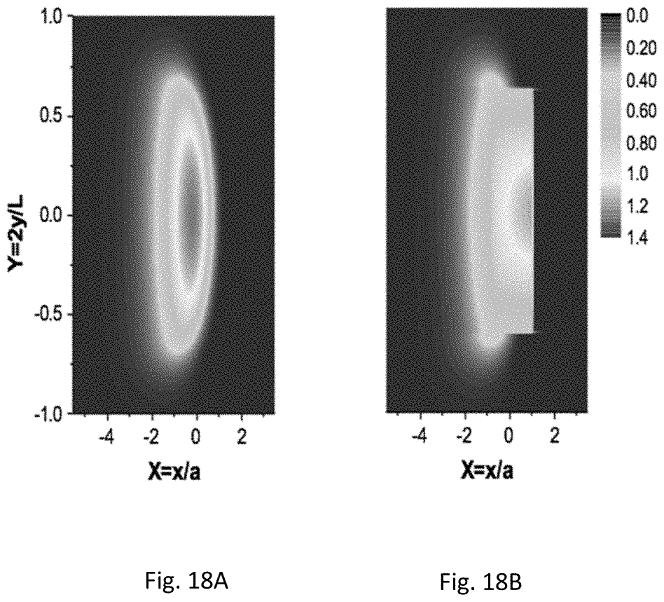

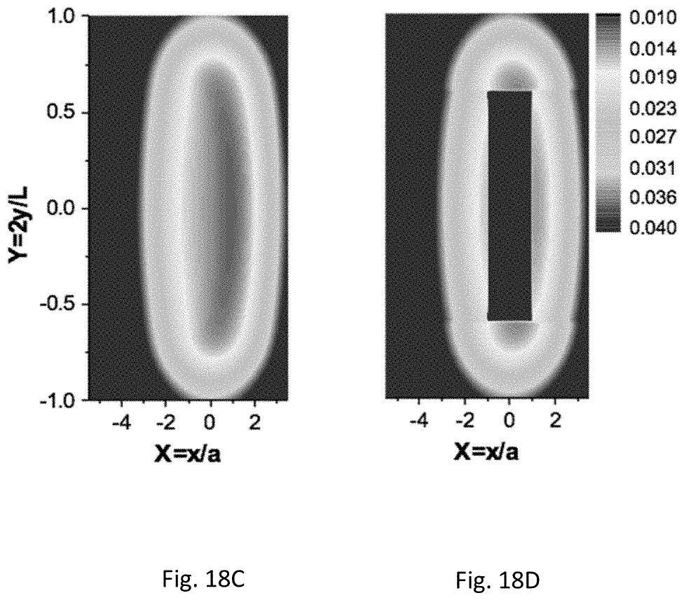

FIG. 18A depicts a pressure distribution for a smooth crowned roller interface in accordance with an illustrative embodiment. FIG. 18B depicts a pressure distribution for a crowned roller interface having optimal partial texturing in accordance with an illustrative embodiment. The optimal partial texturing is the optimal embodiment described with reference to FIGS. 17A-17B. It can be seen in FIG. 18B that the pressure distribution is more uniform with the partially textured crowned roller surface as compared to a smooth surface. FIG. 18C depicts a film thickness distribution for a smooth crowned roller interface in accordance with an illustrative embodiment. FIG. 18D depicts a film thickness distribution for a crowned roller interface having optimal partial texturing in accordance with an illustrative embodiment.

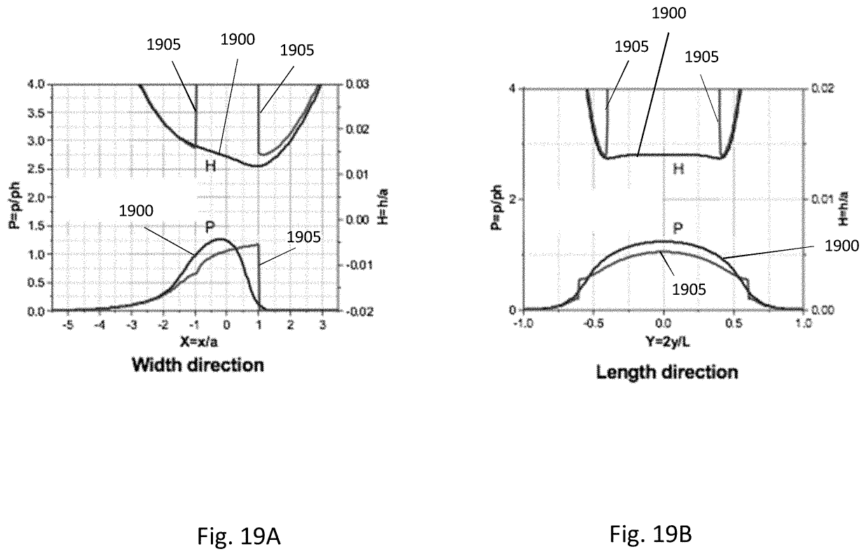

FIG. 19A depicts a centerline pressure comparison (bottom) and a film comparison (top) in a width direction for a crowned roller interface in accordance with an illustrative embodiment. The comparisons are between a smooth embodiment without partial texturing and an embodiment that includes optimal partial texturing on the crowned roller. In FIG. 19A, data for the smooth embodiment is represented by lines 1900 and data for the partially textured embodiment is represented by lines 1905. FIG. 19B depicts a centerline pressure comparison (bottom) and a film comparison (top) in a length direction for a crowned roller interface in accordance with an illustrative embodiment. In FIG. 19B, data for the smooth embodiment is again represented by lines 1900 and data for the partially textured embodiment is again represented by lines 1905.

The analysis associated with FIGS. 17-19 indicates that the use of partial texturing can help to form oil reservoirs to increase lubrication, can form a step bearing, can improve pressure smoothness, and can result in a reduction of the divergent region. It was also determined that the optimal embodiment for partial texturing on a crowned roller interface can reduce the CoF by ˜67% and can increase minimum film thickness by ˜14.7% as compared to embodiments without partial texturing.

While several of the embodiments described herein involved rotary engines and seals, it is important to note that applications of the described embodiments are not so limited. The described embodiments can be used in any sliding contact assembly known in the art, including crowned (or other) roller-surface interfaces, crowned (or other) roller-roller interfaces, roller-housing interfaces, etc. The embodiments described herein can be used to improve efficiency in a number of different sliding/rolling contact applications such as a rotary engine, a cam follower, rolling bearings, ratcheting mechanisms, rollers for timing chains, sleeve bearings, pumps, etc.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more”.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A sliding contact assembly comprising:
a first surface;
a second surface that is configured to slide over the first surface, wherein at least a portion of the second surface contacts the first surface to form at an interface between the first surface and the second surface; and
a plurality of textures on the portion of the second surface that contacts the first surface, wherein a density of the plurality of textures is not uniform over the portion of the second surface that contacts the first surface.

2. The sliding contact assembly of claim 1, wherein the plurality of textures are disposed along a centerline of the portion of the second surface that contacts the first surface.

3. The sliding contact assembly of claim 1, wherein the plurality of textures are disposed along a leading edge of the portion of the second surface that contacts the first surface.

4. The sliding contact assembly of claim 1, wherein a distance between centers of adjacent textures is a Hertz contact radius.

5. The sliding contact assembly of claim 1, wherein the plurality of textures comprise indentations.

6. The sliding contact assembly of claim 5, wherein the indentations have an R-type depth profile.

7. The sliding contact assembly of claim 5, wherein the indentations have a T3-type depth profile.

8. The sliding contact assembly of claim 5, wherein the indentations have a depth in a range from 0.1 μm to 7 μm.

9. The sliding contact assembly of claim 5, wherein each of the indentations has a width that is less than or equal to a Hertz contact radius.

10. The sliding contact assembly of claim 1, wherein the textures are square or oval in shape.

11. The sliding contact assembly of claim 1, wherein the textures are configured to reduce friction at the interface.

12. The sliding contact assembly of claim 1, wherein the first surface comprises a housing, and wherein the housing includes a pair of parallel grooves to prevent leakage at the interface.

13. The sliding contact assembly of claim 12, wherein the parallel grooves have a depth of at least 5 microns.

14. The sliding contact assembly of claim 12, wherein the parallel grooves have a T3-type depth profile.

15. The sliding contact assembly of claim 12, wherein the parallel grooves have an R-type depth profile.

16. The sliding contact assembly of claim 12, wherein the parallel grooves run along a rotational direction of the second surface.

17. A rotary engine comprising:
a housing having an interior surface that defines a rotor cavity;
a rotor mounted in the rotor cavity, wherein the rotor includes at least one apex;
an apex seal at the at least one apex of the rotor, wherein the apex seal includes a sealing surface that forms an interface between the rotor and the interior surface of the housing;
wherein the rotor is configured such that the sealing surface of the apex seal is in sealing contact with at least one area of the interior surface of the housing as the rotor rotates in the rotor cavity; and
wherein the interior surface of the housing defines a pair of parallel grooves formed within the at least one area of the interior surface of the housing such that the parallel grooves run in a rotational direction of the rotor.

18. The rotary engine of claim 17, wherein the parallel grooves have an R-type depth profile or a T3-type depth profile.

19. The rotary engine of claim 17, wherein a sealing surface of the apex seal includes a plurality of textures, and further wherein a density of the plurality of textures is not uniform over the sealing surface of the apex seal.

20. The rotary engine of claim 19, wherein a distance between centers of adjacent textures is a Hertz contact radius.
